(19) United States
(12) Patent Application Publication
(10) Pub. No.: US 2014/0265220 A1
(43) Pub. Date: Sep. 18, 2014

(54) Low Profile Derailleur For Chain Driven Personal Vehicle

(71) Applicant: Zike, LLC, Greenville, SC (US)

(72) Inventors: Nathan A. Scolari, Greenville, SC (US); George Reiter, Taylors, SC (US)

(73) Assignee: Zike, LLC, Greenville, SC (US)

(21) Appl. No.: 14/204,063

(22) Filed: Mar. 11, 2014

Related U.S. Application Data
(60) Provisional application No. 61/790,963, filed on Mar. 15, 2013.

(51) Int. Cl. B62M 9/121

(52) U.S. Cl. CPC B62M 9/121
USPC 280/261; 474/80

(57) ABSTRACT

The present invention is a low profile derailleur for a chain driven personal vehicle with an attachment plate, a frame, a positioning angle included in said attachment plate, a transition rail attached to said attachment plate, a chain guide slidably attached to said transition rail, allowing said chain guide to move laterally in relation to an axis of a wheel carried by said frame causing a chain connected to a drive sprocket nest to move from sprocket to sprocket within said sprocket nest, a spring biasing said chain guide in one direction and a cable for moving said chain guide in an opposite direction causing the chain to move from sprocket to sprocket, an inner surface included in said chain guide for contacting said chain, when said chain guide moves said chain from a larger sprocket in the sprocket nest to a smaller sprocket.

### FIELD OF THE INVENTION

This application relates to a speed changing device for rider propelled vehicles using a chain drive and a sprocket nest with a plurality of different sized sprockets. The sprocket changing device is a derailleur system with a low profile reducing the required ground clearance and wheel diameter which is typically needed with the current derailleurs.

### BACKGROUND OF THE INVENTION

A rider propelled vehicle is generally understood to be typically a two wheeled vehicle with a front free rolling, steerable wheel and a rear free rolling, non-steerable wheel connected to each other by a frame including a rider platform positioned between the wheels on which the rider can support himself. To move, the rider can actuate pedals to provide rotational force on the rear wheel producing locomotion. This locomotion process has been employed for bicycles for quite some time as shown in U.S. Pat. No. 540,977 issued on Jun. 11, 1895.

The limitation to the initial bicycle design was that the pedals were connected to the drive wheel either directly or by a chain. However, this connection was typically a single gear connection. Attempts to improve the efficiency of the connection include the advent of the sprocket nest and derailleur system as shown in U.S. Pat. No. 3,535,950, issued on Oct. 27, 1970. As shown in this reference, the derailleur is disposed at or near the rear sprocket nest.

The derailleur system currently used in bicycles has been engineered to allow the chain to smoothly move to an adjacent sprocket within the sprocket nest at selected locations around each sprocket nest. Each sprocket is modified to provide clearance for chain shifting with a plurality of reduced sized chain pickup teeth with modified shape at selected locations on the sprocket, but with adjacent normally sized teeth providing adequate chain grip and strength around the rest of the sprocket's outer periphery or circumference.

The chain travels in a direction by a movement of the derailleur guiding the chain from the sprocket it is on and feeding the chain onto an adjacent larger sprocket when decreasing the speed or a smaller sprocket when increasing the speed.

The bicycle derailleur devices are physically mounted on the frame of the bicycle and its movement is generally operated by a guide wire or cable extending from a shifting lever, attached on the handle bar, to the derailleur. When the rider selects a new sprocket, the rider moves the lever moving the wire or cable which in turn repositions the derailleur to effect a sprocket change. The derailleur is a sophisticated device that has a fixed structure attached to the frame or rear axle and a movable structure that is held in position by at least one double pivot with multiple heavy duty springs that allow the movable elements to rotate or move in the path of a parallelogram created by two opposing plates hinged to move parallel relative to the other. This movement enables the chain guide portion of the derailleur to move relative to the sprocket nest, in a relatively uniform path, in relation to the guide and the sprockets while minimizing twisting the chain.

In order to function properly, the chain slack that exists when the chain is on the sprocket must be taken up. The amount of chain slack is reduced as the chain moves to larger sprockets. In bicycles, the derailleur chain guide system is positioned to extend well below the axle and frame. This enables the chain to serpentine through the low hanging derailleur guide system by having the chain extend well below the largest of the sprockets. Due to this limitation, derailleurs are not available for vehicles such as scooters which include much smaller wheels and tires and therefore have insufficient clearance for the typical derailleur.

Recently, a new generation of scooters and bicycles has been developed with reciprocating foot pedals, such as U.S. Pat. No. 8,128,111. These vehicles, particularly scooters, have frames that have a very low center of gravity making the vehicles more stable. The frames are so low to the ground that the prior art derailleurs conventionally positioned below the rear sprocket nest are virtually useless. Nevertheless, these vehicles need a shifting device to allow the rider to selectively change speeds. Further, positioning the derailleur adjacent to the rear sprocket nest is not advantageous for such a vehicle as a scooter.

Therefore, it is an objective of the present invention to provide for a derailleur that can be used with a low profile vehicle such as a scooter or standing bicycle.

It is another objective of the present invention to provide for a derailleur that is contained with an area partially defined by the drive sprocket nest.

### SUMMARY OF THE INVENTION

The above objectives are accomplished by providing a low profile derailleur comprising: an attachment plate carried by a frame of a vehicle; a positioning angle included in the attachment plate; a transition rail attached to the attachment plate; a chain guide slidably attached to the transition rail, allowing the chain guide to move laterally in relation to an axis of a wheel carried by the frame, causing a chain connected to a drive sprocket nest to move from sprocket to sprocket within the sprocket nest; a spring biasing the chain guide in one direction and a cable for moving the chain guide in an opposite direction causing the chain to move from sprocket to sprocket; an inner surface included in the chain guide for contacting the chain when the chain guide moves the chain from a larger sprocket in the sprocket nest to a smaller sprocket in the sprocket nest; and, an outer surface included in the chain guide for contacting the chain when the chain guide moves the chain from a smaller sprocket in the sprocket nest to a larger sprocket in the sprocket nest.

The derailleur can be disposed in a shifting area defined by the perimeter of the largest sprocket of the drive sprocket nest. A lifting surface can be included for positioning the chain around its contacting sprocket so that the chain is in contact with over ½ the perimeter of the contacting sprocket. The lifting surface can be an idler.

The derailleur can include a slot in the chain guide for receiving the transition rail. The chain guide can travel along a path defined by a line intersecting the perimeter of the sprockets of the drive sprocket nest. The chain guide can be disposed forward a vertical line intersecting the axis of the drive sprocket nest.

A support plate can be attached to the outer surface and carried by the chain guide and a support wall attached to the support plate and carried by the chain guide. A gap can be defined between the transition plate and the outer surface.

### DESCRIPTION OF THE DRAWINGS

The invention will be better understood with reference to the following drawings that are part of this specification:

FIG. 1 is a prospective view of the invention as attached to a vehicle;

FIG. 2 is a side view of the invention;

FIG. 3 is a side view of the invention;

FIG. 4 is a side view of the invention attached to a vehicle;

FIG. 5 is a side view of the invention from the rear of the vehicle;

FIG. 6 is a perspective view of one embodiment of the invention;

FIG. 7 is a perspective view of one embodiment of the invention;

FIGS. 8A and 8B are side views of one embodiment of the invention; and,

FIG. 9 is a side view of the invention attached to a vehicle.

### DESCRIPTION OF THE INVENTION

Referring to FIG. 1, a vehicle having a frame 10 is shown with a wheel 12 attached by the wheels' axle 14 so that the wheel can rotate about the axle. A drive sprocket nest 16 attached to the wheel so that when rotational force is applied to the sprocket nest, the wheel rotates providing locomotion. In one embodiment, rotational force is delivered to the sprocket nest by a chain 18. The chain can be connected to a pedal sprocket so that when a rider applies force to the pedals of a vehicle the force is transferred to the drive sprocket nest and the rear wheel is rotated.

In order for the chain to be moved from one sprocket to another, derailleur 20 is carried by the frame and causes the chain to move laterally in a direction shown as 22. As the derailleur moves, the chain is forced from the current sprocket to the adjacent sprocket An attachment plate 24 is carried by the frame and secures the derailleur to the vehicle. The attachment plate can include an opening 26 that can receive a portion of the wheel axle. In one embodiment, the attachment plate is carried by the frame and offset from the wheel axle. In order to position the derailleur, the attachment plate can include a positioning angle 28 which positions a transition plate 30 having a transition rail 32 so that the transition rail is disposed along a plane 34. In one embodiment, plane 34 is defined by a line intersecting the perimeters of the sprockets in the drive sprocket nest.

A chain guide 36 is slidably carried by the transition plate so that it can move laterally along path 22. In one embodiment, the chain guide includes a slot 38 that received the transition rail allowing the chain guide to slide about the transition rail. The chain guide can include an inner surface 40 and an outer surface 42 so that the chain is disposed between the inner and outer surfaces. In one embodiment, the outer surface is attached to the chain guide by a support plate 52 (FIG. 3). The support plate can be attached to a support wall 54. A gap 56 can be defined between the support plate and the transition plate. When the chain guide moves the chain is thereby moved from one sprocket to another in the drive sprocket nest. A cable 44 can be attached to the chain guide so that when tension is placed on the cable, the cable pulls the chain guide in a direction shown as 46. Since direction 46 includes directional vector 46a, the chain is moved from an inner sprocket to an outer sprocket of the drive sprocket nest when the cable is tensioned.

When the tension is released from the cable, the spring 48 causes the chain guide to move in a direction opposite 46 including a directional vector opposite 46a causing the chain to move from a smaller sprocket to a larger sprocket in the drive sprocket nest. In one embodiment, the chain guide causes the chain to contact the sprocket in the drive sprocket nest at over ½ the perimeter. In this embodiment, the chain guide includes a lifting surface 50 (FIG. 2) that cause the chain to be supported above the bottom perimeter of the connected sprocket. In one embodiment, the lifting surface is an idler.

Referring to FIG. 4, in one embodiment, the derailleur is disposed in a shifting area defined by the perimeter of the largest sprocket of the drive sprocket nest.

Referring to FIG. 2, slot 38 is shown included in the chain guide so that it can receive the transition rail. The chain guide includes a gap 52 so that the chain guide can move in a direction shown as 54 without interfering with the transition plate. Referring to FIG. 3, the lifting surface 50 is shown disposed between the outer surface and the inner surface of the chain guide. Referring to FIG. 4, the derailleur can be disposed entirely in the area defined by the outer most perimeter of the sprocket nest so that the necessary ground clearance needed for the derailleur is significantly reduced.

Referring to FIG. 5, a top view of the invention is shown attached to a vehicle. Chain 18 is shown contacting drive sprocket nest 16. The chain wraps around the top of the sprocket nest and then around the back and back under the bottom of the sprocket nest. In FIG. 5, the chain is shown at the bottom of the sprocket nest which is the “clack” portion of the chain. The derailleur inner surface 40 is disposed on one side of the chain and outer surface is disposed on the outside of the chain. When the derailleur surfaces move laterally in direction 46a, the chain in moved from sprocket to sprocket. In one embodiment, the inner and outer surface are planar with angled portion 41a and 41b to help prevent the chain from fouling with the chain guide. In another embodiment, the chain guides are rounded as shown in 40′ and 42′.

Referring to FIG. 6, the derailleur is shown from the rear with the with the chain being disposed between the inner and outer plates and an opening 48 disposed above the chain. When carriage 50 move along path 46, the lateral component 46a of path 46 causes the chain to move from sprocket to sprocket.

Referring to FIG. 7, another embodiment of the present invention is shown. In this embodiment, the inner and outer plates define an opening 48 that is disposed beneath the chain. Carriage 50 is slidably attached to transition plate 30 so that the carriage and therefore the inner and outer plates can move laterally in direction 46a causing the chain to move from sprocket to sprocket. Shifting arm 52 is rotatably attached to the transition plate and moves in a direction shown as 54. Spring 48 biases the carriage to the right adjacent to the mounting plate. As the shifting arm rotates, contact member 58 contacts arch 56 on the carriage and forces the carriage away from the mounting plate. As shifting arm rotates, the chain guide moves the chain from sprocket to sprocket. One advantage of having opening 48 directed downward is that the derailleur can be positioned between the drive portion of the chain and the slack portion of the chain reducing the clearance needed by the derailleur.

Referring to FIG. 8, the derailleur is shown with the shifting arm rotated so that the chain guide is moved in a direction 64 from position 60 to position 62 moving the chain from one sprocket to another. In this embodiment, the spring is compressed and when tension is released from the shifting arm, the chain guide returns to position 60.

Referring to FIG. 9, the carriage 50 is shown positioned with a shifting area 68. The shifting area can be defined as the space between a tangent 70 at the lower point of the largest sprocket of the rear sprocket nest and a tangent 72 at the highest point of the largest sprocket of the rear sprocket nest. Therefore, the limitations of clearance for the derailleur are defined by the sprocket nest itself and not the derailleur. In one embodiment, the shifting area is further defined by a vertical line 74 intersecting the axis of the rear axle so that the carriage, inner plate and outer plate are disposed forward of line 74.

In one embodiment, a tension member is included having a tension arm 82, roller or sprocket 76 and tension spring 80 so that the chain is biased upward in a direction 78. In one embodiment the lowers point of the tension arm is even with or above line 70. The tension arm move upwards and downward as the chain move from sprocket to sprocket with the tension arm at its lowest point when the chain is on the largest sprocket of the sprocket nest.

One embodiment of the invention as described herein is directed to a scooter, as used herein, a scooter is a vehicle having typically two wheels, but could have three, but is so designed to have the rider standing on the pedals. The use of pneumatic tires, solid rubber or urethane tires does not change the device from a scooter to a bicycle. It is understood, however, the present invention with the addition of a seat for the rider, would take on the appearance of a pedal drive bicycle, as such the use of the present invention with a seat would also be considered within the scope of the present invention, but it must be appreciated that the maximum driving speed of the rear wheel is most easily performed standing. The vehicle can be motorized or non-motorized

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A low profile derailleur for a chain driven personal vehicle comprising:
an attachment plate carried by a frame of the personal vehicle;
a positioning angle included in said attachment plate;
a transition rail attached to said attachment plate;
a chain guide slidably attached to said transition rail, allowing said chain guide to move laterally in relation to an axis of a wheel carried by said frame causing a chain connected to a drive sprocket nest to move from sprocket to sprocket within said sprocket nest;
a spring biasing said chain guide in one direction and a cable for moving said chain guide in an opposite direction causing the chain to move from sprocket to sprocket;
an inner surface included in said chain guide for contacting said chain, when said chain guide moves said chain from a larger sprocket in the sprocket nest to a smaller sprocket in the sprocket nest; and,
an outer surface included in said chain guide for contacting said chain, when said chain guide moves said chain from a smaller sprocket in the sprocket nest to a larger sprocket in the sprocket nest.

2. The derailleur of claim 1 wherein said derailleur is disposed in a shifting area defined by the perimeter of the largest sprocket of the drive sprocket nest.

3. The derailleur of claim 1 including a lifting surface for positioning the chain around its contacting sprocket so that the chain is in contact with over ½ the perimeter of the contacting sprocket.

4. The derailleur of claim 1 wherein said lifting surface is an idler.

5. The derailleur of claim 1 including a slot in said chain guide for receiving said transition rail.

6. The derailleur of claim 1 wherein said chain guide travels along a path defined by a line intersecting the perimeter of the sprockets of the drive sprocket nest.

7. The derailleur of claim 1 wherein said vehicle is a scooter.

8. The derailleur of claim 1 wherein said chain guide is disposed forward a vertical line intersecting the axis of the drive sprocket nest.

9. The derailleur of claim 1 including a support plate attached to said outer surface and carried by said chain guide.

10. The derailleur of claim 9 including a support wall included with said support plate and carried by said chain guide.

11. The derailleur of claim 10 including a gap defined between said transition plate and said outer surface.

12. A chain driven personal vehicle with a low profile derailleur comprising:
an attachment plate attached to a frame;
a steerable front wheel and rear wheel carried by said frame;
a drive sprocket nest attached to said rear wheel;
said chain connected to a drive sprocket included in said drive sprocket nest;
a transition rail attached to said attachment plate; and,
a chain guide slidably attached to said transition rail allowing said chain guide to move laterally in relation to an axis of a wheel carried by said frame, causing said chain to move from sprocket to sprocket within said sprocket nest as said chain guide travels along a path defined by the perimeter of the sprockets of the drive sprocket nest;

13. The vehicle of claim 12 wherein said chain guide is disposed in a shifting area defined by the perimeter of the largest sprocket in the drive sprocket nest.

14. The vehicle of claim 12 including a lifting surface for positioning the chain around its contacting sprocket so that the chain is in contact with over ½ the perimeter of the contacting sprocket.

15. The vehicle of claim 14 wherein said lifting surface is an idler.

16. A low profile derailleur for a chain driven personal vehicle comprising:
a transition rail carried by a frame of a personal vehicle oriented along a line defined by the perimeter of the sprockets of a drive sprocket nest;
a chain guide slidably attached to said transition rail for moving a chain from sprocket to sprocket in said drive sprocket nest when said chain guide travels along said transition rail; and
a shifting area defined by the perimeter of the largest sprocket in said drive sprocket nest wherein said derailleur is disposed in said shifting area.

17. The derailleur of claim 16 including a lifting surface for positioning the chain around its contacting sprocket so that the chain is in contact with over ½ the perimeter of the contacting sprocket.

18. The derailleur of claim 16 including:
an inner surface included in said chain guide for contacting said chain when said chain guide moves said chain from a larger sprocket in the sprocket nest to a smaller sprocket in the sprocket nest; and,
an outer surface included in said chain guide for contacting said chain when said chain guide moves said chain from a smaller sprocket in the sprocket nest to a larger sprocket in the sprocket nest.

19. The derailleur of claim 16 including an attachment plate for securing said chain guide to said frame.

20. The derailleur of claim 19 including a positioning angle so that said transition rail is oriented along a line defined by the outer edges of the sprocket nest.
